(19) United States
(12) Patent Application Publication
(10) Pub. No.: US 2015/0356475 A1
(43) Pub. Date: Dec. 10, 2015

(54) FEEDBACK MECHANISMS FOR INSURANCE WORKFLOW OPTIMIZATION

(71) Applicant: Hartford Fire Insurance Company, Hartford, CT (US)

(72) Inventors: James S. Rogers, Willington, CT (US); Samantha A. DeRosa, Tolland, CT (US)

(73) Assignee: Hartford Fire Insurance Company, Hartford, CT (US)

(21) Appl. No.: 14/295,865

(22) Filed: Jun. 4, 2014

(51) Int. Cl. G06Q 10/06

(52) U.S. Cl. CPC G06Q 10/0633; G06Q 40/08

(57) ABSTRACT

Embodiments provide a method for giving feedback for insurance workflow optimization. The method may include an easy to understand indication, e.g., a visual such as a light bulb that changes hue, which is representative of a metric regarding how workflows are being managed. In an example embodiment, insurance agent data submissions may be processed to categorize each of the plurality of insurance agent data submissions, e.g., as preferred workflow type and non-preferred workflow type. On this basis, a metric may be determined to reflect a proportion of preferred workflow type and non-preferred workflow type in the insurance agent data submissions received. This metric may in turn be formed into an instruction that reflects the metric, with the instruction being communicated to a device at an insurance agency, e.g., a device including a light bulb of changing hue that provides an indication of the metric. Other aspects are described and claimed.

### BACKGROUND

In a variety of contexts existing workflows may be streamlined, made more efficient, conducted in a more user-friendly fashion, focused to more effectively achieve a particular goal, or otherwise improved. Different workflows for a particular task develop over time for a number of reasons. For example, developments in technology can bring about new workflows for accomplishing various tasks. Sometimes the new workflows compliment the existing ones, whereas in other situations a new workflow may be preferred.

Often for tasks that may be accomplished in different ways, the various participants may prefer certain of the workflows that may be used. One example task in the insurance industry is that of submission of data to an insurance carrier, e.g., submission of endorsement data to an insurance carrier (or like data) to obtain a quote.

This traditionally involved communicating with the insurance carrier relevant data such that the insurance carrier could provide a quote for the requesting insurance agent. As technology progressed, the mechanisms used to communicate such data also progressed. For example, with the advent of the Internet, insurance carriers began taking data submissions via a web portal. Eventually more custom data management systems were developed for insurance agents such that the insurance agent could enter data once to receive quotes from many insurance carriers, e.g., for a specific individual or business, by entering this data into a data management system for submission to multiple insurance carriers.

In this example environment, it may be appreciated that the different mechanisms of data communication between insurance agent and insurance carrier have different attributes or features. Here, it may occur that a particular insurance carrier prefers that data submissions be made by an insurance agent using the data management system, e.g., for consistency of input, streamlined processing, efficiency, etc. On the other hand, an insurance agent may prefer or simply have a habit of using a legacy mechanism, e.g., a web portal.

### BRIEF SUMMARY

In summary, an embodiment includes a method of providing feedback for insurance workflow optimization. The method may include an easy to understand indication, e.g., a visual such as a light bulb that changes hue, which is representative of a metric regarding how workflows are being managed. In an example embodiment, insurance agent data submissions may be processed to categorize each of the plurality of insurance agent data submissions, e.g., as preferred workflow type and non-preferred workflow type. On this basis, a metric may be determined to reflect a proportion of preferred workflow type and non-preferred workflow type in the insurance agent data submissions received. This metric may in turn be formed into an instruction that reflects the metric, with the instruction being communicated to a device at an insurance agency, e.g., a device including a light bulb of changing hue that provides an indication of the metric.

Additional embodiments are described, including other methods, as well as devices/apparatuses, systems including multiple devices, and products.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates a high level view of an example system for providing feedback mechanisms for insurance workflow optimization.

FIG. 3 illustrates an example method for providing feedback mechanisms for insurance workflow optimization.

FIG. 4 illustrates an example workflow optimization system.

FIG. 5 illustrates an example output of a workflow optimization system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As described herein, there may be more than one workflow or process for completing a task. In the example of an insurance data submission, e.g., by an insurance agent to an insurance carrier for a quote or like response, an insurance agent may choose to submit the data via a carrier proprietary (web) portal or via an agency data management system. Further, the various types of data submissions or communication may have sub-types. For example, in using a data management system, a user may choose to log in with an identification (ID) and password or may choose to utilize a single sign on (token based process).

In the case where an insurance agent chooses to use the web portal, the data submission will be limited to a single insurance carrier as the web portals are insurance carrier specific. In contrast, should the insurance agent choose to submit the data via the data management system, it may be submitted to multiple insurance carriers simultaneously or in parallel. Thus for example an insurance agent will not need to recall an insurance carrier specific password for logging into a web portal if the data management system is used, and the insurance agent will not have to re-enter data for each new submission if the data management system is used.

Over and above this consolidation, the receiving insurance carriers may in fact prefer that the insurance agents and insurance agencies use the data management system for such submissions, as the insurance carriers often have built in systems that are compatible with the data management system, whereas the legacy web portals may or may not be compatible with other systems of the insurance carriers. Among other difficulties, this use of the web portal rather the data management system leads to duplication of efforts, e.g., data entry and processing, form handling, etc., that may be avoided if the data management system is utilized by the insurance agent for the data submission. Additionally, the data management system may be more secure, particularly if a single sign on process is utilized. Thus, from the perspective of the insurance carriers and the insurance agents, there is some advantage to using the data management system workflow rather than the web portal workflow.

A difficulty arises, however, in the persistence of the legacy workflows in that many workers, e.g., insurance agents, are in the habit of utilizing the same. Conventional efforts to encourage such insurance agents to resort to a preferred workflow type may be made but these are often ineffectual for a variety of reasons. For example, incentives, whether monetary or otherwise, are often not linked in time such that those seeking the incentives may not make a positive association between workflow choice and incentive receipt. Additionally, standard communication such as discussions in meetings and the like tend to lose effectiveness over time and are otherwise inefficient.

Accordingly, an embodiment provides feedback for insurance workflow optimization. A method may include an easy to understand indication, e.g., a visual such as a light bulb that changes its hue (which includes color change) based on performance. This indication, which is representative of a metric regarding how workflows are being managed by a site such as an insurance agency provides immediate or intermittent feedback that conveniently notifies and reminds workers of their performance with respect to a metric of interest, in this case use of a preferred insurance workflow type.

In an example embodiment, insurance agent data submissions may be processed to categorize each of the plurality of insurance agent data submissions, e.g., as preferred workflow type and non-preferred workflow type. The insurance carrier receiving the data submissions via various mechanisms such as web portals and data management systems may accomplish this categorization.

On this basis, a metric may be determined to reflect a proportion of preferred workflow type and non-preferred workflow type in the insurance agent data submissions received. This metric, while useful to the insurance carrier, may also in turn be formed into an instruction that reflects the metric, with the instruction being communicated to a device at an insurance agency, e.g., a device including a light bulb of changing hue that provides an indication of the metric. In this way, feedback regarding uses of or adherence to a preferred workflow may be provided, e.g., in real time or periodically/intermittently, such that the insurance agents remain apprised of performance in this regard on an on-going basis.

The illustrated example embodiments will be best understood by reference to the figures. The following description is intended only by way of example, and simply illustrates certain example embodiments.

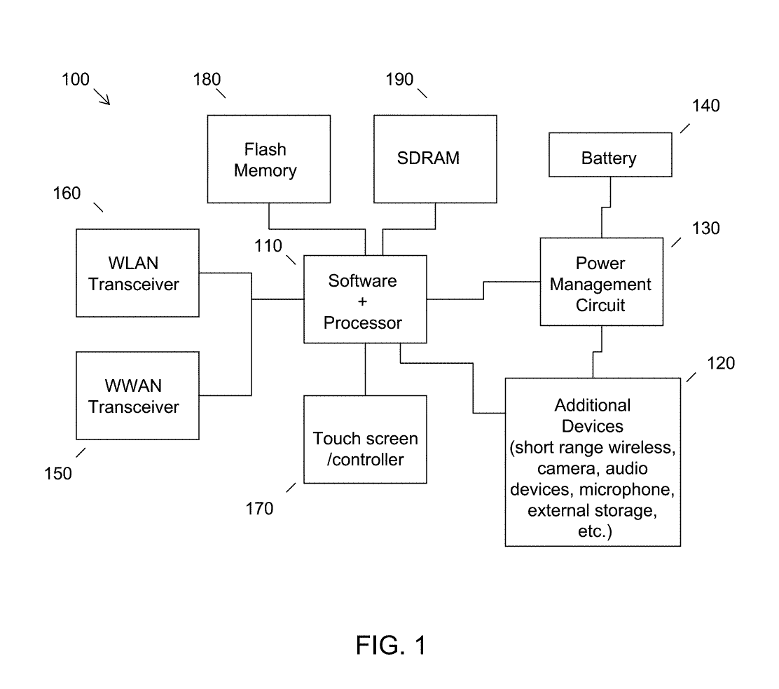

While various other circuits, circuitry or components may be utilized in information handling devices, an example illustrated in FIG. 1 includes a system design found for example in tablet or other mobile computing platforms. Software and processor(s) are combined in a single unit 110. Internal busses and the like depend on different vendors, but essentially all the peripheral devices (120) may attach to a single unit 110. The circuitry 100 combines the processor, memory control, and I/O controller hub all into a single unit 110. Also, systems 100 of this type do not typically use SATA or PCI or LPC. Common interfaces for example include SDIO and I2C.

There are power management circuits(s) 130, e.g., a battery management unit, BMU, which manage power as supplied for example via a rechargeable battery 140, which may be recharged by a connection to a power source (not shown). In at least one design, a single unit, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additional devices 120 are commonly included. Commonly, system 100 will include a touch screen/controller 170 for data input and display. System 100 also typically includes various memory devices, for example flash memory 180 and SDRAM 190.

Information handling device circuitry, as for example outlined in FIG. 1, may be used in devices that are used by insurance agents to submit data to insurance carriers. Circuitry such as that outlined in FIG. 1 may also be used by insurance carriers that receive data submissions from insurance agents, e.g., for processing the data submissions into categories, calculation of metric(s) regarding workflow type used or other parameters of interest, and communicating instructions regarding the same. It will also be apparent that circuitry such as outlined in FIG. 1 may be used in an insurance agency device, e.g., that receives the instruction(s) from the insurance carriers and effects a notification regarding the same.

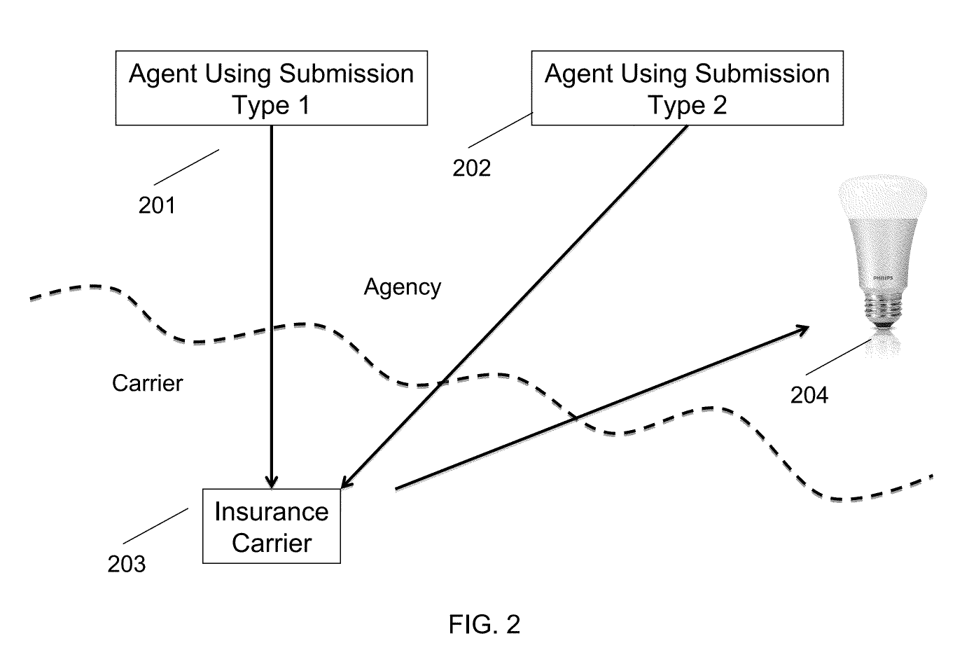

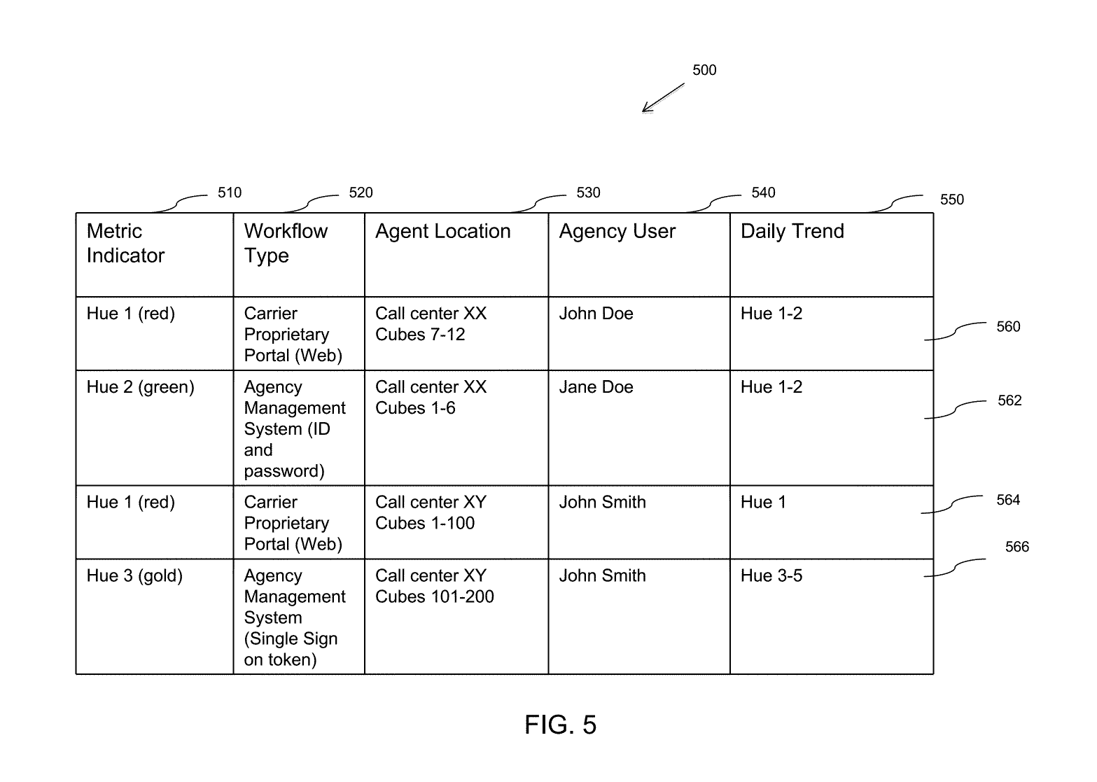

In an embodiment, referring now to FIG. 2, a system providing feedback for insurance workflow optimization may include components both at an insurance agency and at an insurance carrier, as illustrated. In the example of FIG. 2, an insurance carrier device 203, such as a computer or system, e.g., as illustrated in FIG. 1 or FIG. 5, that includes or has access to a database and a network interface, receives data submissions from insurance agents 201, 202, respectively, over a network connection such as the Internet. The insurance carrier device 203 may directly receive the submissions form the insurance agents 201, 202 using devices such as including circuitry outlined in the example of FIG. 1 and/or FIG. 5, and/or may access submissions stored in a database or otherwise provided by intermediate device(s).

In any event, the data submissions are received at the insurance carrier device 203 such that a processor of the insurance carrier device 203, e.g., operatively connected to the database and/or the network interface, may execute instructions stored in a memory to receive and process the submissions from the insurance agents 201, 202.

As a specific and non-limiting example, an insurance carrier device 203 may receive, over a network connection facilitated by the network interface such as 150 and/or 160 of FIG. 1, a plurality of insurance agent data submissions from the insurance agents 201, 202. These submissions and/or data regarding the same may be processed by the insurance carrier device 203 to categorize each of the plurality of insurance agent data submissions (e.g., Type 1 and Type 2 generally in FIG. 2).

As described herein, this processing may include categorizing the plurality of insurance agent data submissions to assign a type and/or sub-type to each of the plurality of insurance agent data submissions for inclusion into a group or sub-group, e.g., preferred workflow type and non-preferred workflow type. By doing this, the insurance carrier device 203 creates data that may be used to determine a metric that reflects a proportion of preferred workflow type and non-preferred workflow type of the plurality of insurance agent data submissions. As such, the insurance carrier device 203 may form an instruction, such as computer or device code, which reflects the metric. This instruction may then be communicated by the insurance carrier device 203, e.g., using a network connection such as the Internet, to a device 204 at the insurance agency, e.g., from which the data submissions originated.

Thus, the system may further include a device 204 of an insurance agency configured with an application that receives the instruction and provides an indication of the metric. In the example of FIG. 2, the device 204 is equipped with a light bulb that changes its hue according to the instruction, which is in turn keyed to the metric calculated by the insurance carrier device 203. Such hue-changing light bulbs, which may be wirelessly controlled, are available conventionally and may be adapted to, e.g., via use of an application that converts the metric-keyed instruction to an instruction understood by the light bulb device, provide a convenient, readily changeable, and easily understood visual notification of the current metric, e.g., for a particular insurance agency with regard to workflow performance. Philips Corporation manufactures an example hue changing light bulb under the trade name HUE.

As may be appreciated, other agency device(s) 204 may be used in lieu of or in addition to a light bulb. For example, a visual notification such as an icon (e.g., virtual light bulb, etc.) may be provided on a device screen, e.g., a mobile device running an application that accesses the instructions provided by the insurance carrier device 203, such as a tablet device used by insurance agents 201, 202. As another example, the insurance agency device 204 may be a manager's device at the insurance agency such that he or she is apprised of workflow performance. As another example, the insurance agency device 204 may be a group device, such as one visible to a group of employees to encourage or incentivize the group with visual feedback (and/or other modality) regarding performance or compliance with workflow preferences of an insurance carrier. Combinations of insurance agency devices 204 may likewise be used.

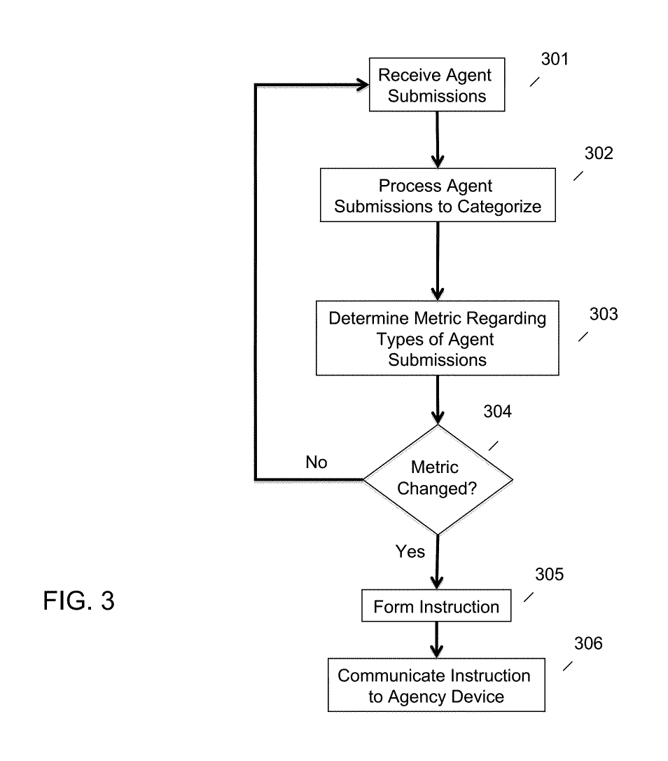

In FIG. 3 an example method of providing feedback for insurance workflow optimization is illustrated. As shown, an insurance carrier device 203 may receive, over a network connection, a plurality of insurance agent data submissions at 301. These data submissions may be processed at 302 to categorize each of the plurality of insurance agent data submissions, e.g., into a type such as preferred workflow type (such as an agency management system submission) and non-preferred workflow type (such as a carrier proprietary portal), noting that there may be more than two workflow types and/or sub-types.

An embodiment may determine a metric at 303, e.g., to reflect a proportion of preferred workflow type and non-preferred workflow type of the plurality of insurance agent data submissions. This permits an insurance carrier device 203 to monitor and determine if there has been a change in the workflow metric for an insurance agency at 304. Optionally, if no change to the metric has been determined at 304, the insurance carrier device 203 may not form and issue a new instruction, but rather may await further submissions that change the metric, e.g., by some predetermined amount. Alternatively, even if the metric has not changed, an instruction (e.g., the same instruction that was previously used) may be formed and communicated to the agency device(s) 204.

If a change in the metric is determined at 304, e.g., over a predetermined threshold, an insurance carrier device 203 may form, at 305, an instruction that reflects the metric. This instruction, as indicated, may be formed in a way such that it is mapped to a signal or instruction for a particular insurance agency device 204. In the example of the light bulb 204, an instruction may include information for directing a light bulb such as a mapped signal indicating a hue value for the light bulb with respect to the current metric value.

It is worth noting at this point that the metric value may take a variety of forms. The term proportion is used throughout as a representative term for a relative degree of workflow type usage. This may be a true proportion based only on a single agency's data submissions, on a single agent's data submissions, and/or may be scaled in some fashion, e.g., relative to a geographic region (such as a state or city), relative to a type of data submission or types of data submissions, etc.

Having formed an appropriate instruction or signal given the type of metric and/or the type of agency device(s) 204 to be modified, an embodiment may then communicate, at 306, the instruction to a device 204 at an insurance agency. Again, the device 204 may take a variety of forms, including a distributed form such that multiple agency devices 204 are used, so long as the device 204 of the insurance agency is configured with an application and/or component that receives the instruction and provides an indication of the metric.

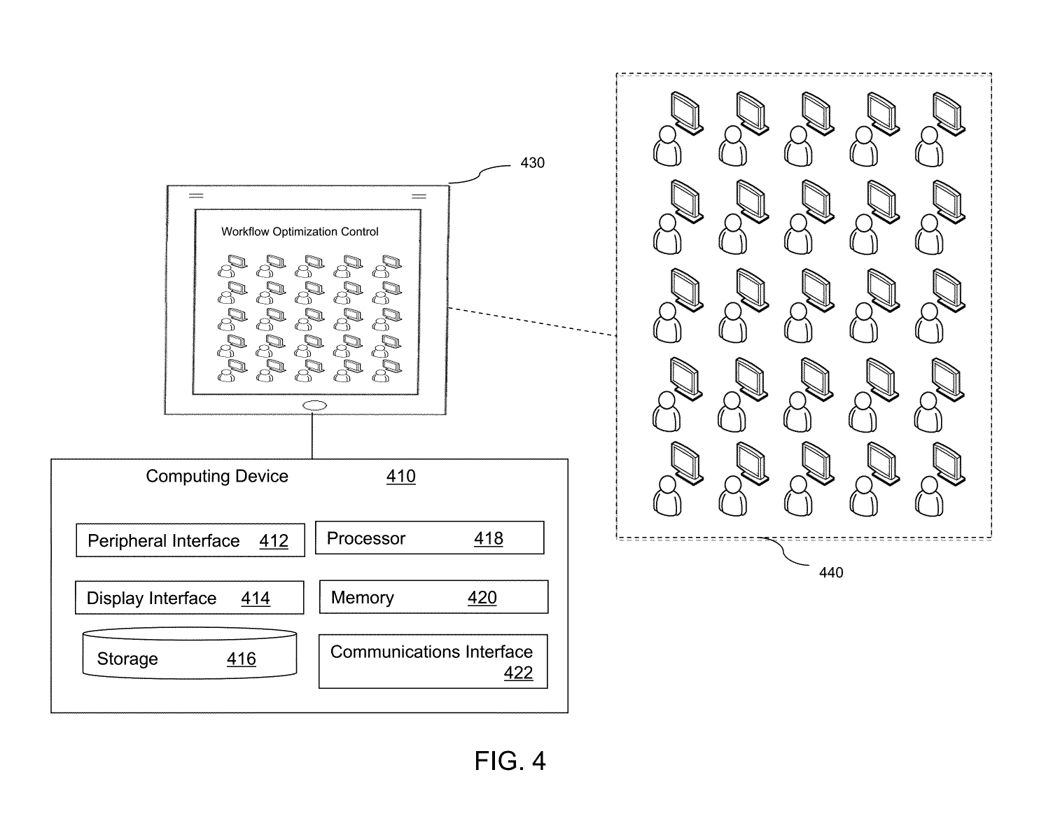

Turning to FIG. 4, an example workflow optimization system is illustrated. The example system, which may take the form of a computer or like device used by an insurance carrier and/or an insurance agency employee (e.g., an agency manager), includes computing device 410. As illustrated, the computing device 410 may include a processor 418, memory 420 and storage 416. The computing device may receive (or otherwise access) data related to submissions made by insurance agents, e.g., submissions using the various workflow types referred to herein. The submissions (or data relating to the submissions) may be received via a communications interface 422, such as a component that permits connection to a network such as the Internet or a corporate network, etc. The submissions/data relating thereto may be stored in a storage 416 such that they may be processed, e.g., as outlined in FIG. 3, by an application of computing device 410 loaded into memory 420.

Computing device 410 may include a display 430, e.g., displaying graphics such as workers at the agency 440. The data for inclusion in the display 430 may be output from the computing device 410, e.g., using a processor and a display interface 414. Computing device 410 may also include a peripheral interface 412, e.g., for outputting an instruction reflecting the metric to a peripheral device, e.g., a device such as device 204 including a light bulb of changing hue.

By way of example, and referring now to FIG. 5, the output of the system may include a display 500 of information regarding workflow type compliance. This display 500 may include data that is displayed, e.g., on display 430, and/or may include data stored in a location, e.g., storage 416, used for creating metrics and/or instructions, as further described herein. In the example of FIG. 5, the output may be tabulated and include column sorted data, e.g., including columns such as metric indicator 510, workflow type 520, location 530, agency user 540, and daily trend 550. Other columns or values may be utilized, as this is a non-limiting example.

Within the display 500 are rows of each column populated with data. In the example of FIG. 5, the rows 560, 562, 564, and 566 are associated with different locations. The rows, for example rows under the workflow type 520 column, may include a descriptor such as “carrier proprietary portal (web)”, “agency management system (ID and password)” or “agency management system (single sign on token)”, etc., depending on what modality or type (or sub-type) of workflow submission was used by the location associated therewith. These indicators may be plain language descriptions of the workflow type such that a manager or other employee, e.g., of an insurance agency and/or carrier, may quickly determine which types of workflows are involved. Likewise, the location 530 values may include a descriptor such as “call center xx, cubes 7-12”, etc., which permits the employee viewing display 500 to be apprised of the location of the employee(s), e.g., one of workers illustrated graphically in 440, that submitted the workflow item. In addition, agency user descriptor, such as “John Doe” 540, may be included in order to associate an agency user with the employee(s)/location(s) that created or is associated with the submission.

The display 500 may also include a metric indicator 510 that is assigned to the workflow type or sub-type, the location, and/or the agency user. In the example of FIG. 5, the “carrier proprietary portal (web)” value is a type of workflow that originated from a specific location, i.e., “call center xx—location 7-12” and is overseen by agency user “John Doe”. This submission type has been assigned or mapped to a metric value, i.e., “Hue 1”. By way of example, this may be a direct mapping for a particular submission type, e.g., “carrier proprietary portal (web)”=“Hue 1”. As may be appreciated, certain hue values, e.g., Hue 2 and Hue 3, may represent preferred and most preferred workflow type and sub-type, respectively. These may be associated with Huessuch as green or gold, whereas a non-preferred workflow type, e.g., “carrier proprietary portal (web)” may be associated with another hue value and hue/color, e.g., Hue 1 and red.

A scaled or aggregated value, such as daily trend 550 also may be included. In this example, the daily trend 550, e.g., for the location “call center xx—cubes 7-12”, is “Hue 1-2”, indicated in row 560. This quickly apprises the reviewing employee of the performance trend (which may be another unit of time, e.g., current, weekly, monthly, yearly, etc.). Thus, for each such collection in the display 500, a trend may be compiled. In the example of FIG. 5, the trends (reflected in rows 560, 562, 564, and 566) are represented in the illustrated daily trends of “Hue 1-2”, “Hue 1-2”, “Hue 1”, and “Hue 3-5”, respectively.

It will be understood then that the metric indicator 510 may be formed into, or a reflection of, the current instruction sent to the agency device 204. For example, the metric indicator 510 of FIG. 5 for location “call center xx—cubes 7-12” is currently “Hue 1”. This may correspond to a particular color, e.g., red, such that the agency device 204 operates an application to cause the light bulb of agency device 204 to display a red hue. This provides a current, e.g., real-time, indication of the current compliance or non-compliance for the particular location, employee/manager, etc. In this example, the red hue for this location/manager may indicate that the call center would, if submitting data in another format (e.g., agency management system versus carrier proprietary portal), be given a different hue, e.g., green for compliance with a preferred workflow submission type. Similarly, if the agency management system single sign on type was used, which is more secure and thus is most preferred, a most preferred hue may be assigned, e.g., Hue 3 and a gold color. In this way, an embodiment may provide convenient, real-time feedback for the locations and/or managers such that they are quickly apprised of location level or even employee level compliance with preferred workflow types.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable storage medium(s) may be utilized. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A system providing feedback for insurance workflow optimization, comprising:
a database;
a network interface;
a processor operatively connected to the database and the network interface; and
a memory that stores instructions executable by the processor to:
receive, over a network connection facilitated by the network interface, a plurality of insurance agent data submissions;
process, using the processor, the plurality of insurance agent data submissions to categorize each of the plurality of insurance agent data submissions;
the plurality of insurance agent data submissions being further processed to assign a type to each of the plurality of insurance agent data submissions, where the type is selected from the group of preferred agency management system type and non-preferred carrier proprietary portal type;
determine, using the processor, a metric to reflect a proportion of workflow types of the plurality of insurance agent data submissions;
form, using the processor, an instruction that reflects the metric; and
communicate, using a network connection facilitated by the network interface, the instruction to a device at an insurance agency;
wherein the instruction includes information to direct the device of an insurance agency to provide an indication of the metric.

2. The system of claim 1, wherein the instruction is formed such that it is keyed to a hue representative of the metric.

3. The system of claim 2, wherein the instruction is formed such that it is keyed to a light bulb hue representative of the metric.

4. The system of claim 3, wherein the instruction is formed such that it automatically modifies a light bulb hue representative of the metric.

5. The system of claim 1, wherein the instruction includes information to direct a device screen to display an icon representative of the metric.

6. The system of claim 1, wherein the icon is a virtual light bulb.

7. The system of claim 1, wherein processing further comprises separating a group of the plurality of insurance agent data submissions based on agency origin.

8. The system of claim 7, wherein the metric reflects an agency specific proportion.

9. The system of claim 8, wherein the agency specific proportion is scaled based on performance of a geographic region.

10. A method of providing feedback for insurance workflow optimization, comprising:
receiving, over a network connection, a plurality of insurance agent data submissions;
processing, using a processor of an insurance carrier device, the plurality of insurance agent data submissions to categorize each of the plurality of insurance agent data submissions;
the processing further including assigning a type to each of the plurality of insurance agent data submissions, where the type is selected from the group of preferred workflow type and non-preferred workflow type;
determining, using a processor of an insurance carrier device, a metric to reflect a proportion of preferred workflow type and non-preferred workflow type of the plurality of insurance agent data submissions;
form, using a processor of an insurance carrier device, an instruction that reflects the metric; and
communicating, using a network connection, the instruction to a device at an insurance agency
wherein the instruction includes information to direct the device of an insurance agency to provide an indication of the metric.

11. The method of claim 10, wherein the instruction is formed such that it is keyed to a hue representative of the metric.

12. The method of claim 11, wherein the instruction is formed such that it is keyed to a light bulb hue representative of the metric.

13. The method of claim 12, wherein the instruction is formed such that it automatically modifies a light bulb hue representative of the metric.

14. The method of claim 10, wherein the instruction includes information to direct a device screen to display an icon representative of the metric.

15. The method of claim 10, wherein the icon is a virtual light bulb.

16. A system providing feedback for insurance workflow optimization, comprising:
an insurance carrier device, comprising:
a database;
a network interface;
a processor operatively connected to the database and the network interface; and
a memory that stores instructions executable by the processor to:
receive, over a network connection facilitated by the network interface, a plurality of insurance agent data submissions;
process, using the processor, the plurality of insurance agent data submissions to categorize each of the plurality of insurance agent data submissions;
the plurality of insurance agent data submissions being further processed to assign a type to each of the plurality of insurance agent data submissions, where the type is selected from the group of preferred workflow type and non-preferred workflow type;
determine, using the processor, a metric to reflect a proportion of preferred workflow type and non-preferred workflow type of the plurality of insurance agent data submissions;
form, using the processor, an instruction that reflects the metric; and
communicate, using a network connection facilitated by the network interface, the instruction to a device at an insurance agency;
wherein the instruction includes information to direct the device of an insurance agency to provide an indication of the metric.

17. The system of claim 16, wherein the device of an insurance agency comprises a wirelessly controlled light bulb;
wherein the instruction is formed such that it automatically modifies the wirelessly controlled light bulb hue according to the metric.

18. The system of claim 16, wherein the device of an insurance agency comprises a mobile device;
wherein the instruction is formed such that it automatically modifies a visual graphic provided on a display of the mobile device.

19. The system of claim 16, wherein the device of an insurance agency comprises a group device;
wherein the instruction is formatted such that it automatically modifies a visual indicator of the group device.

20. The system of claim 16, wherein the insurance carrier device communicates the instruction according to a rule selected from the group of continuous communication and intermittent communication.
